(19) United States
(12) Patent Application Publication
(10) Pub. No.: US 2007/0091389 A1
(43) Pub. Date: Apr. 26, 2007

(54) Automatic original document transport device and image forming device equipped with the same

(76) Inventor: Masayuki Kakuta, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,225

(22) Filed: Oct. 26, 2005

(51) Int. Cl. H04N 1/04

(52) U.S. Cl. 358/498

(57) ABSTRACT

In an automatic original document transport device, there are provided a contact image sensor 10 for scanning an image of an original document 34, and an original document guide member 11 for guiding the original document 34 to the original document scanning surface 13a so as to incline with respect to the original document scanning surface 13a. Therefore, an angle d formed by the optical axis b of the light source 14 and transported original document 34 becomes large, resulting in sufficient radiation of light from the light source 14 to the light source 14. Therefore, when the original document 34 is scanned, an excellent image is obtained, and particularly when a pasted original document is scanned, the problem of a pasted end appearing on the image as a line can be effectively avoided.

### FIELD OF THE INVENTION

The present invention relates to an automatic original document transport device for flow-scanning an original document comprising scanning means for scanning an original document, and to an image scanning device comprising the same.

### BACKGROUND INFORMATION

In general, an image scanning device provided in a scanner, digital photocopier, facsimile device or the like is configured so that light from a light source is incident upon an original document, and light reflected from the original document is imaged by an image sensor such as, for example, a CCD sensor, thus scanning the image of an original document image.

Further, an image scanning device of this kind is known to comprise an automatic original document transport device for flow-scanning an original document. In this case, it is configured so that an original document loaded on an original document feed tray of an automatic original document transport device is fed into an automatic original document transport device, and transported to a contact glass provided in the image scanning device. The original document is then irradiated by the image scanning device light source, and based on light reflected by the original document, an image on one side of the original document is scanned by the above described CCD sensor.

Further, an image scanning device is known in which a contact image sensor is disposed in an automatic original document transport device, and the other side of the original document is scanned by the contact image sensor. More specifically, as shown in FIG. 4, the contact image sensor 50 comprises a contact glass 52 having a box-like sensor frame 51 and original document scanning surface 52a. Further, in the sensor frame 51, there are provided a light source 53 for irradiating an original document P, a lens array 54 for converging the light reflected by the original document, and a scanning element (photoelectric transducer) 55 into which enters the reflected light converged by the lens array 54.

Further, there are provided a transport roller 57 opposite the contact image sensor 51, and in the original document transport direction upstream of the contact image sensor 51, an original document guide member 56 for guiding the original document P to the original document scanning surface 52a. The original document P guided by the original document guide member 56 in the original document transport direction (i.e. the arrow X direction in the drawing) is irradiated by the light source 53. Next, the light reflected from the original document P is converged by the lens array 54 to enter into the scanning element 55 via the lens array 54. Next, the reflected light is converted to electrical signals upon image formation on the scanning element 55, and the other surface of the original document P is thus scanned.

Generally, in such a contact image sensor, as shown in FIG. 4, in view of such factors as cost reduction and restrictions in space for installation, the light source 53 is provided only on one side of the optical axis A of the scanning element 55. However, with such a constitution, light may not be sufficiently irradiated on the original document on the other side of the optical axis A in which the light source 53 is not provided. Further, as shown in FIG. 4, because the original document guide member 56 is provided roughly parallel to the original document scanning surface 52a, an angle D formed by the optical axis B of the light source 53 and the original document to be transported at the original document scanning surface 52a becomes smaller. Therefore, when an original document on which, for example, other paper has been pasted (“pasted original document”) is scanned, it becomes easy for a shadow to form at the pasted end positioned on the original document surface on the other side. As a result, the end may appear on an image as a line.

Thus, a contact image sensor has been disclosed in which a reflective surface for partly reflecting light emitted from a light source is provided. More specifically, on a part of a contact glass, the reflective surface is provided, so that light emitted from the light source in one direction is partly reflected, and light is radiated on the original document scanning surface from a direction other than such one direction. This results in a constitution identical to a case where a light source is provided on the other side of the scanning element optical axis where a light source is not provided.

However, even when the contact image sensor comprising a reflective surface, as described above, is configured in an identical manner to a case where a light source is provided also on the other side of the scanning element optical axis, the original document guide member is provided roughly parallel to the original document scanning surface, as in the contact image sensor shown in FIG. 4. Therefore, the above described pasted end still tends to cast a shadow, and as a result, the problem of the end appearing on the image as a line is not completely resolved.

Further, the above original document guide member 56, as shown in FIG. 5, is configured so that the end 56a of the original document scanning surface 52a is roughly parallel with the longitudinal direction W, not forming an angle with respect to the original document scanning surface 52a in the longitudinal direction W of the original document scanning surface 52a. Therefore, when the original document P having an image to be scanned by the contact image sensor 50 passes the end 56a on the original document scanning surface 52a side of the original document guide member 56, the entire rear edge of the original document P is in contact with the original document scanning surface 52a at the same time, leading to cases where transport of the original document P does not occur smoothly. Therefore, the original document P receives a blow, and as a result, there may be blurring on the scanned image of the original document P. This problem also occurs in the contact image sensor provided with the above described reflective surface.

Further, with the above conventional contact image sensor comprising a reflective surface, light from a light source must be radiated onto the reflective surface, leading to increased size of the contact image sensor, making this unsuitable for reducing device size.

Thus, the present invention was conceived in light of the above problems, and its object is to provide an automatic original document transport device that is suitable to reducing device size, that prevents blurring of an original document scanned image, and that obtains an excellent image even when a pasted original document is scanned, and to provide an image scanning device comprising the same.

### SUMMARY OF THE INVENTION

To achieve the object, an automatic original document transport device of the present invention comprises a contact image sensor having a contact glass provided on an original document transport path, a light source for irradiating the original document that passes the contact glass, and a scanning element for scanning the original document image upon incidence of light reflected from the original document, and an original document guide member for guiding the original document to the contact glass original document scanning surface, such guide member being disposed on the original document transport direction upstream of the contact image sensor, wherein the original document guide member is provided so as to be inclined with respect to the original document scanning surface.

Thus, the automatic original document transport device of the present invention may be configured such that the original document guide member is disposed so that the angle at the original document scanning surface formed by the light source optical axis and original document is roughly a right angle. Further, the automatic original document transport device of the present invention may be configured so that the end on the guide member original document scanning surface extends in the original document transport direction, from the center of the longitudinal direction of the original document scanning surface to both ends. Further, the end on the guide member original document scanning surface is formed roughly in a V-shape in the original document transport direction.

Further, the image scanning device of the present invention comprises any one of the automatic original document transport devices described above.

The automatic original document transport device of the present invention is configured so that the original document guide member is provided so as to be inclined with respect to the original document scanning surface. Therefore, the angle formed by the light source optical axis and transported original document becomes larger, and thus sufficient light is radiated from the light source onto the original document. As a result, an excellent image can be obtained when an original document is scanned; in particular, when a pasted original document is scanned, the problem of a pasted end appearing on an image as a line can be effectively avoided. Further, because an excellent image can be obtained without having to provide a reflective surface for irradiating light from a light source as in the above conventional contact image sensor, the need to increase the size of a contact image sensor can be avoided, and as a result, this constitution is suitable for smaller devices.

Further, the original document guide member is disposed so that the angle on the original document scanning surface formed by the light source optical axis and original document is roughly a right angle. Therefore, when an original document is scanned, an excellent image can be obtained; in particular, when a pasted original document is scanned, the problem of a pasted end appearing on an image as a line is completely avoided.

Further, the end on the guide member original document scanning surface extends in the original document transport direction, from the center of the longitudinal direction of the original document scanning surface to both ends, and the end on the guide member original document scanning surface is formed roughly in a V-shape in the original document transport direction. Therefore, when an original document passes the end on the original document scanning surface side, the original document can be smoothly transported, reducing the impact on the original document. As a result, blurring on an original document scanned image can be effectively prevented, enabling an excellent image to be obtained.

Further, because the image scanning device of the present invention may comprise any one of the automatic original document transport devices described above, the same effects can be obtained with any of the automatic original document transport devices described above.

### BRIEF DESCRIPTION OF THE DRAWINGS

FIG. 1 is a schematic view showing the overall constitution of an image scanning device relating to the embodiment of the present invention;

FIG. 2 is a schematic view illustrating the overall constitution of the contact image sensor provided in an automatic original document transport device relating to the embodiment of the present invention;

FIG. 3 is a partial enlarged view illustrating a configuration of an original document transport guide provided in an automatic original document transport device relating to the embodiment of the present invention;

FIG. 4 is a schematic view illustrating the overall constitution of a contact image sensor provided in a conventional automatic original document transport device; and

FIG. 5 is a partial enlarged view for illustrating a configuration of an original document transport guide provided in a conventional automatic original document transport device.

### DETAILED DESCRIPTION OF THE PREFERRED EMBODIMENTS

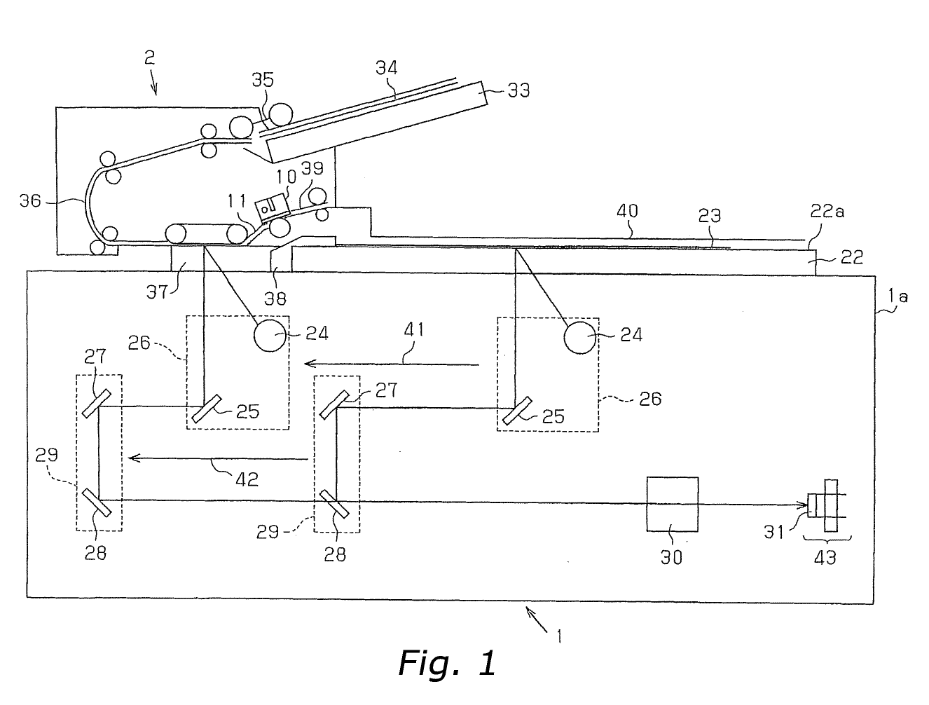

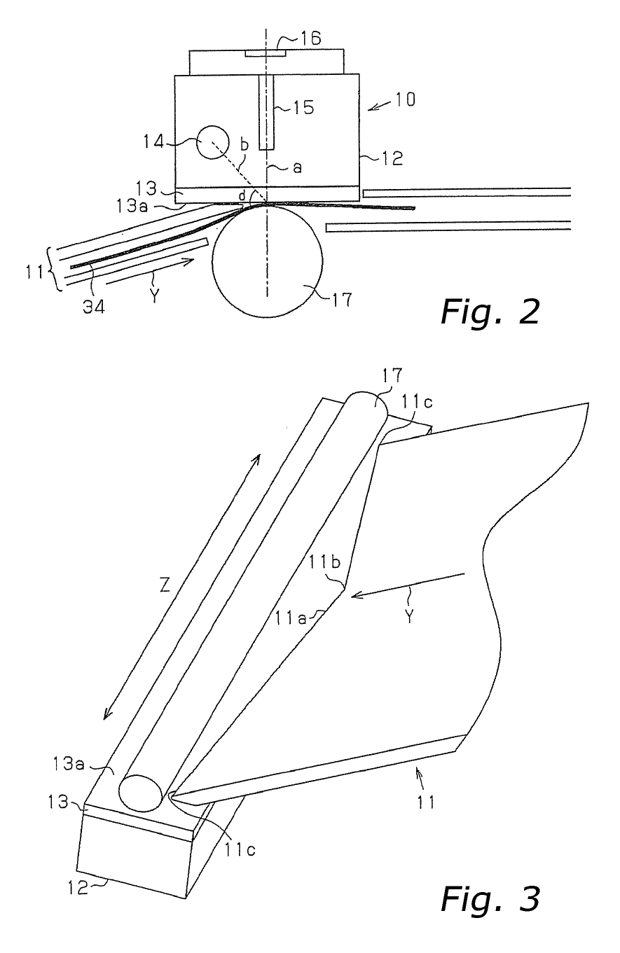

A specific embodiment of the present invention will be explained with reference to the drawings. FIG. 1 is a schematic view showing the overall constitution of an image scanning device relating to the embodiment of the present invention. FIG. 2 is a schematic view illustrating the overall constitution of a contact image sensor provided in an automatic original document transport device relating to the embodiment of the present invention. Also, FIG. 3 is a partial enlarged view illustrating a configuration of an original document transport guide provided in an automatic original document transport device relating to the embodiment of the present invention.

In FIG. 1, an image scanning device 1 comprises an image scanning device main body 1a, a platen contact glass 22 and flow scan contact glass 37 provided on the upper surface of the image scanning device main body 1a, and an original document size indicating member 38 provided adjacent to the platen contact glass 22 and flow scan contact glass 37. The original document size indicating member 38 serving as a size indicator of an original document 23 loaded on the platen contact glass 22 is formed of, for example, polystyrene, ABS or other resin.

The image scanning device main body 1a comprises a first optical unit 26 comprising a light source 24 serving as a light source that irradiates light on the original document 23 placed on the platen contact glass 22, and a first mirror 25 for reflecting the irradiated light reflected by the original document 23 in a 90-degree direction. Further, the image scanning device main body 1a comprises a second optical unit 29 comprising a second mirror 27 for reflecting the light reflected by the first mirror 25 in a 90-degree direction and a third mirror 28 for reflecting the light reflected by the second mirror 27 in a further 90-degree direction.

Further, in the image scanning device main body 1a, there are provided an imaging lens 30, and a CCD unit 43 containing a CCD sensor 31 serving as an image sensor. The light reflected from the original document 23 reflected by the third mirror 28 is converged by an imaging lens 30 provided so as to face the CCD sensor 31, and is caused to be incident upon the CCD sensor 31 via the imaging lens 30, thereby, forming an image on the CCD sensor 31. The light of the image from the scan of the original document 23 is converted to electrical signals by the CCD sensor 31, and the light and shade of the original document image is converted to electrical signal levels.

Thus in the present embodiment image, scanning means for scanning an original document image comprises the first optical unit 26, second optical unit 29, imaging lens 30 and CCD unit 43, such scanning carried out based on the light radiated by the light source 24 and reflected by the original document 23. For the present embodiment, a xenon fluorescent lamp, halogen fluorescent lamp, fluorescent light and other fluorescent lamps may be used as the light source 24.

Further, in the above constitution, the imaging lens 30 and CCD sensor 31 are fixed to the image scanning device main body 1a; however, they need to be configured so that an original document side optical path length does not change even when the light source 24 moves in a scanning direction. Therefore, the first optical unit 26 comprising the light source 24 and first mirror 25, and the second optical unit 29 comprising the second mirror 27 and third mirror 28 are provided so that each can move at a constant speed. The first and second optical units 26, 29 are moved and stopped by optical unit drive means (not shown in the drawings).

Further, the image scanning device 3 of the present embodiment comprises an automatic original document transport device 2 for flow-scanning an original document. The automatic original document transport device 2 comprises an original document feed tray 33, a paper feed unit 35 for feeding the original document 34 loaded on the original document feed tray 33, and an original document transport path 36 for transporting the fed original document 34.

When the original document 34 is flow scanned, the original document 34 loaded on the original document feed tray 33 of the automatic original document transport device 2 is fed into the automatic original document transport device 2 by the paper feed unit 35, and transported to the flow scan contact glass 37 through the original document transport path 36. At this time, the first optical unit 26 and second optical unit 29 are moved by drive control means (not shown in the drawings) at a constant speed in the directions indicated by arrows 41, 42 respectively at prescribed timings, and the original document 34 that passes the flow scan contact glass 37 is stopped at a position where scanning is possible and scanning thus commences of the image on one surface of the original document 34. In this case as well, the image of the original document 34 is scanned by image scanning means identical to that used for general image scanning as described above.

Further, in the automatic original document transport device 2 of the present embodiment, there are provided a contact image sensor 10 for scanning the other surface of the original document 34, and an original document guide member 11 for guiding the original document 34 to the original document scanning surface disposed on the original document transport direction upstream of the contact image sensor 10.

The contact image sensor 10, as shown in FIG. 2, comprises a box-like sensor frame 12, and a contact glass 13 disposed on the original document transport path and having the original document scanning surface 13a. Further, in the sensor frame 12, there are provided a light source 14 for radiating the original document 34 that passes the contact glass 13, a lens array 15 for converging the light reflected from the original document 34, and a scanning element (photoelectric transducer) 16 into which the reflected light converged by the lens array 15 enters. Further, a transport roller 17 is provided opposite the contact image sensor 10.

The original document 34, having passed the flow scan contact glass 37 and one surface of which having been scanned is transported in the original document transport direction, that is, the arrow Y direction as shown in the drawings, by the original document guide member 11, and guided to the original document scanning surface 13a of the contact glass 13. Next, light is radiated on the original document 34 by the light source 14, and the light reflected from the original document 34 is converged by the lens array 15 to enter into the scanning element 16 via the lens array 15. The reflected light is converted into electrical signals after image formation on the scanning element 16, and the image on the other surface of the original document 34 is scanned by the scanning element 16.

Further, the automatic original document transport device 2 comprises an original document output transport path 39 for outputting the original document 34, and an original document output tray 40 onto which the output original document 34 is loaded. The original document 34, the other surface of which was scanned by the contact image sensor 10, is output outside the automatic original document transport device 2 via the original document output transport path 39 and is loaded on the original document output tray 40.

Here, a feature of the present embodiment is the disposition of the original document guide member 11 with respect to the original document scanning surface 13a. More specifically, as shown in FIG. 2, the original document guide member 11 for guiding the original document 34 to the original document scanning surface 13a is provided so as to incline with respect to the original document scanning surface 13a.

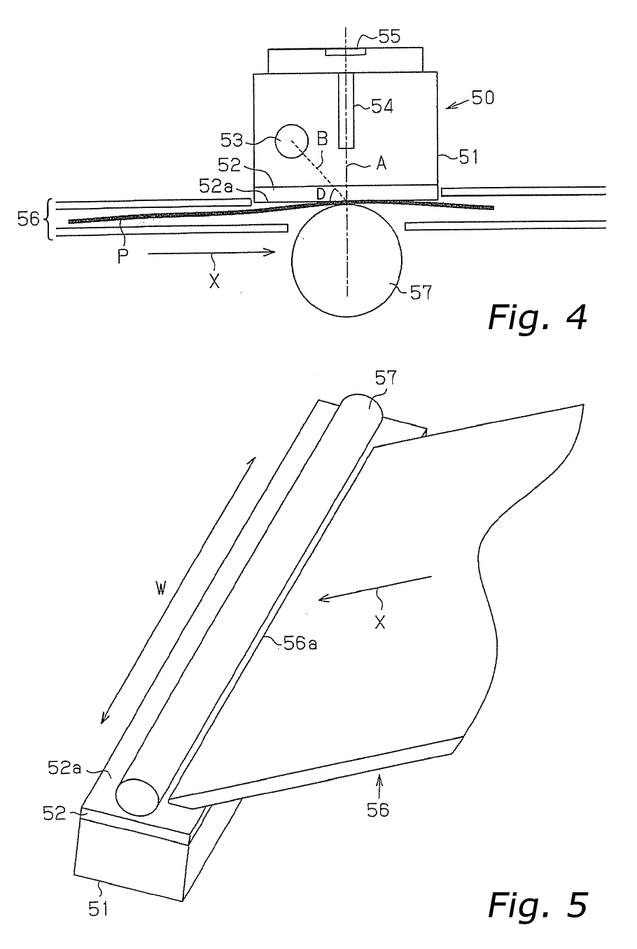

As described above, because the prior art shown in FIG. 4 is configured such that an original document guide member 56 for guiding an original document P to an original document scanning surface 52a is provided so as to be roughly parallel to the original document scanning surface 52a, an angle D at the original document scanning surface 52a formed by the optical axis B of the light source 53 and transported original document P becomes small. On the other hand, because the present embodiment is configured such that the original document guide member 11 is provided so as to incline with respect to the original document scanning surface 13a, the angle of the original document 34 entering the original document scanning surface 13a becomes large (that is, the angle with respect to the optical axis a of the scanning element 16 becomes large). Therefore, as shown in FIG. 2, compared to the prior art, an angle d at the original document scanning surface 13a formed by the optical axis b of the light source 14 and transported original document 34 becomes larger (i.e. d>D), and because the angle d approaches roughly a right angle, the other surface of the original document 34 to be scanned is sufficiently irradiated with light from the light source 14. Therefore, when the original document 34 is to be scanned, an excellent image can be obtained, and particularly when a pasted original document is scanned, the problem of a pasted end appearing on the image as a line can be effectively prevented.

Alternatively, the original document guide member 11 may be disposed so as to incline with respect to the original document scanning surface 13a so that the angle d at the original document scanning surface 13a formed by the optical axis b of the light source 14 and transported original document 34 is roughly a right angle. With such a constitution, when the original document 34 is scanned, an exceptional image can be obtained, and particularly when a pasted original document is scanned, the problem of a pasted end appearing on the image as a line can be completely avoided.

Further, the original document guide member 11 of the present embodiment, as shown in FIG. 3, is configured so that the end 1a on the original document scanning surface 13a, from the center 11b of the longitudinal direction Z of the original document scanning surface 13a to both ends 11c, extends in the original document transport direction Y, and the end 11a is formed roughly in a V-shape in an original document transport direction Y.

With such a constitution, when the rear edge of the original document 34 having an image to be scanned by the contact image sensor 10 passes the end 11a on the original document scanning surface 13a of the original document guide member 11, first, the center of the rear edge of the original document 34 is brought in contact with the original document scanning surface 13a. Next, the rear edge of the original document 34 is gradually brought in contact with the original document scanning surface 13a starting from the center and moving out to both ends. Therefore, the original document 34 can be smoothly transported to the original document output tray 40 via the original document output transport path 39, reducing the impact on the original document 34. As a result, blurring on the scanned image of the original document 34 can be effectively prevented, and an excellent image can be obtained.

As described above, the present embodiment is configured so that the original document guide member 11 is provided so as to incline with respect to the original document scanning surface 13a. Therefore, the angle d formed by the optical axis b of the light source 14 and the transported original document 34 becomes larger, resulting in sufficient radiation of light from the light source 14 onto the original document 34. As a result, when the original document 34 is scanned, an excellent image can be obtained, and particularly when a pasted original document is scanned, the problem of pasted end appearing on the image as a line can be effectively avoided.

Further, an excellent image can be obtained without providing a reflective surface for radiating light from the light source, as in the above conventional contact image sensor; such a constitution enables a size increase of the contact image sensor 10 to be avoided, and as a result, is suitable for smaller devices.

Further, the original document guide member 11 is disposed so that an angle at the original document scanning surface 13a formed by the optical axis b of the light source 14 and the original document 34 is roughly a right angle. Therefore, when the original document 34 is scanned, an exceptional image can be obtained and particularly when a pasted original document is scanned, the problem of pasted end appearing on the image as a line can be completely avoided.

Further, the end 11a on the original document scanning surface 13a of the original document guide member 11, from the center 11b in the longitudinal direction Z of the original document scanning surface 13a to the both ends 11c, extends in the original document transport direction Y Therefore, the original document 34 can be smoothly transported when passing the end 11a on the original document scanning surface 13a of the original document guide member 11, easing the impact on the original document 34. As a result, blurring on the scanned image of the original document 34 can be effectively prevented, enabling an excellent image to be obtained.

The above embodiment merely serves to illustrate the invention and should not be construed as limiting the claims. Various other modifications may be made with respect to the shapes, sizes, materials of each component without departing from the technological essence and spirit the present invention, and the foregoing are not excluded from the scope of claims.

For example, in the above embodiment, the end 11a on the original document scanning surface 13a of the original document guide member 11 is formed roughly in a V-shape in the original document transport direction Y. Alternatively, it may be formed in various shapes, provided that the end 11a, from the center 11b of the longitudinal direction Z to the both ends 11c, extends in the original document transport direction Y For example, the end 11a may be formed roughly in an arc-shape.

What is claimed is:

1. An automatic original document transport device comprising:
a contact image sensor having a contact glass provided on an original document transport path, a light source for radiating with light the original document that passes the contact glass, and a scanning element for scanning the original document image upon entrance of light reflected from the original document; and
an original document guide member for guiding the original document to the contact glass original document scanning surface disposed on the original document transport direction upstream of the contact image sensor,
wherein
the original document guide member is provided so as to incline with respect to the original document scanning surface.

2. An automatic original document transport device according to claim 1, wherein the original document guide member is disposed so that the angle at the original document scanning surface formed by the light source optical axis and original document is roughly a right angle.

3. An automatic original document transport device according to claim 1, wherein the end of the guide member original document scanning surface extends in the original document transport direction, from the center in the longitudinal direction on the original document scanning surface to both ends thereof.

4. An automatic original document transport device according to claim 3, wherein the end is formed roughly in a V-shape in the original document transport direction.

5. An image scanning device comprising any one of the automatic original document transport devices according to claims 1 though 4.
